(19) United States
(12) Patent Application Publication
(10) Pub. No.: US 2010/0236648 A1
(43) Pub. Date: Sep. 23, 2010

(54) FILLING MACHINE FOR HIGHLY COMPRESSED GAS

(75) Inventors: Chen Bong Cheng, Hong Kong (HK); Ping Man Tam, Hong Kong (HK)

Correspondence Address: SUGHRUE MION, PLLC, 2100 PENNSYLVANIA AVENUE, N.W., SUITE 800, WASHINGTON, DC, 20037, US

(73) Assignee: ENERGETIC TECHNOLOGY DEVELOPMENT LIMITED, Hong Kong (HK)

(21) Appl. No.: 12/723,387

(22) Filed: Mar. 12, 2010

(30) Foreign Application Priority Data
Mar. 20, 2009 (CN) 200910129651.X

(51) Int. Cl. F16K 21/04; F04B 35/04; F16L 35/00; F01B 29/00; F16H 53/00

(52) U.S. Cl. 137/565.13; 417/410.1; 137/800; 92/161; 74/567

(57) ABSTRACT

The present invention refers to a filling machine for highly compressed gas, comprising: an electric driver, a reduction gearbox, a driving shaft, an eccentric driving mechanism, an high-compression mechanism, a cylinder manifold and a framework, wherein the eccentric driving mechanism consisting of at least two eccentric driving wheels is mounted on the driving shaft, the high-compression mechanism consists of at least two oscillating type compression gas cylinders connected in series by a plurality of one-way valves and hoses, and a slip ring, a piston rod and a piston are joined into an integral block wherein the slip ring is fitted over the eccentric driving wheel and the other end of the piston rod is connected to a gas cylinder barrel so as to be fitted over a supporting shaft; the supporting shaft is provided in the framework and the framework is provided with a cylinder manifold on the top thereof, which is provided with a pressure switch, a pressure gauge and a safety valve; the outer circumferential portion of the compression gas cylinder is provided with bump-and-depression textures for heat elimination, the framework is provided with a cooling fan therein, and the framework is provided with a transparent cover; the electric driver drives the reduction gearbox to transfer rotation movement to the driving shaft so as to rotate the eccentric driving wheels, and subsequently drives the integral block of the slip ring, the piston rod and the piston to reciprocate linearly with respect to the gas cylinder barrel in order to compress gas so that the output gas subjected to multistage compression can be filled into a high pressure gas tank.

### TECHNICAL FIELD

The present invention mainly relates to a filling machine for highly compressed gas, specialized in highly compression of gas and consequent filling of the gas into a high pressure gas tank, to be used by common consumers or in various specialized fields, so as to match the need of extra high pressure gas tanks present in the current market which are made of composite material and have a large capacity.

### BACKGROUND ART

The present invention provides a filling machine for highly compressed gas, the compressing operation of which is mainly produced by cooperative operation of a set of high-compression mechanisms and a set of eccentric driving mechanisms; the set of high-compression mechanisms used in the present invention comprises at least two oscillating type compression gas cylinders of different sizes, and the set of the eccentric driving mechanisms comprises at least two eccentric driving wheels which are fixedly mounted on a driving shaft in sequence, spaced apart by an angle of 120°; when the driving shaft rotates clockwise slowly, the driving shaft immediately drives the at least two eccentric driving wheels mounted thereon to rotate simultaneously, and each eccentric driving wheel immediately drives an associated integral block of a slip ring, a piston rod and a piston to reciprocate linearly with respect to an associated gas cylinder barrel so that each associated oscillating type compression gas cylinder performs its gas compressing operation.

The present invention uses a set of high-compression mechanisms which comprises at least two oscillating type compression gas cylinders of different sizes, and also uses cooperatively with a set of eccentric driving mechanisms, as a basis of the compressing operation technology according to the present invention. An operation technology using eccentric driving wheels to perform a gas compressing operation is early disclosed by U.S. Pat. No. 2,105,765 (inventor: Fourness); and an operation technology using at least two oscillating type compression gas cylinders of different sizes to perform a gas compressing operation is also disclosed in detail by U.S. Pat. No. 2,628,015 (inventor: Neugebauer et al) long before.

In recent years and at present, there are a number of published or announced patent documents which provide similar gas compressing devices based on the technologies of using eccentric driving wheels and using a plurality of compression gas cylinders, or a number of such products which have been sold in the market; however, gas compressing or filling devices or machines provided to common consumers or various specialized fields in the market at present for simple and convenient use still cannot meet common requirements, two defects of which are as follows: firstly, the output gas pressure cannot meet the high requirements at present, and thus they can only fill conventional gas tanks, but generally cannot meet or match the needs of containment of more highly compressed gas in high pressure gas tanks made of composite materials in present advanced science and technology; secondly, even if at present there are similar high pressure gas compressing or filling devices or machines which are able to match the use of high pressure gas tank in the market, most of the devices or machines have a too slow filling speed.

The near term published or announced patent documents, which refer to technologies using a plurality of compression gas cylinders of different sizes or using eccentric driving wheels to provide the above discussed similar or same kind of gas compressing devices or machines, are as follows: Chinese Patent Application Publication No. CN1828119A (inventor: ZHENG Zhen Bang), Chinese Paten Application Publication No. CN101070833A (inventor: ZHENG Zhen Bang), or Chinese Patent Announcement No. CN2761870Y.

The above mentioned Chinese Patent Announcement No. CN2761870Y refers to using a plurality of compression gas cylinders of different sizes in order to compress natural gas, characterized in that, it can meet the needs of large gas displacement and belongs to a large-scale compression structure, which is not very suitable to be used by common consumers or in various specialized fields for simple and convenient use; therefore, as compared with the filling machine for highly compressed gas according to the present invention, the above mentioned Chinese Patent Announcement No. CN2761870Y should not be considered as the same kind of products needed by common consumers.

According to the above mentioned Chinese Patent Application Publication No. CN101070833A, its compressing operation uses an eccentric driving wheel to drive three compression gas cylinders of different sizes, and according to the above mentioned Chinese Patent Application Publication No. CN1828119A, its compressing operation uses at least two eccentric driving wheels to drive at least two compression gas cylinders of different sizes in sequence; as compared with the filling machine for highly compressed gas provided by the present invention, the outstanding design of the present invention is that the fulcrums of the pistons as well as the fulcrums of the eccentric driving wheels are located in a same plane and the fulcrums of both of them are also in the plane, while according to the relative designs disclosed by Chinese Patent Application Publication No. CN101070833A and Chinese Paten Application Publication No. CN1828119A, the pistons are in a same plane, but the fulcrums of the pistons and the fulcrums of the eccentric driving wheels are located in different planes so as to produce a leverage effect, which produces an unnecessary oscillation affecting the steady operation of the structure; when compared in terms of power and speed, the filling machine for highly compressed gas according to the present invention has advantages that it highly increases the filling pressure, and highly increases the speed for filling gas into a high pressure gas tank, so that it highly reduces the time for filling a high pressure gas tank.

Due to fast development of science and technology in composite materials, high pressure gas tanks made of composite materials, which combine high-strength materials such as carbon fiber, glass fiber, high-strength aluminum alloy or titanium alloy, have been used widely in a plurality of fields. The pressure in the high pressure gas tanks is 50˜100% higher than that in conventional gas tanks, and the weight of the high pressure gas tanks is more than 50% lighter than that of conventional gas tanks. Therefore, it is necessary to improve the gas compressing technology and gas filling technology, in order to match the need of the extra high pressure gas tanks present in the current markets which are made of composite material and have a large capacity.

In view of the defects in the performances of the prior high pressure gas tanks and gas filling machines, through careful and in-depth research and sufficient testing and verification, the present invention now, by applying an innovative technology and a suitable design combination, provides a new generation of filling machines for highly compressed gas; the filling machine for highly compressed gas provided by the present invention has a driving shaft rotation speed up to 75 rpm, which reaches an output gas pressure up to 3000 psi via a third stage of compression gas cylinder; taking a gas tank of the same pressure model (model: M6-2000 psi) as a reference, the same kind of products provided in the market have a gas filling speed of 40 minutes to 110 minutes, while the filling machine for highly compressed gas according to the present invention has a gas filling speed of only 30 minutes.

The high-compression technology provided by the present invention enables gas to be filled into a high pressure gas tank in simple manner after being highly compressed, so as to match and meet the needs of extra high pressure gas tanks made of composite materials in current market which have a large gas capacity; the gas filling machine for highly compressed gas according to the present invention enables the gas filling speed to be highly increased so that the gas filling time is highly reduced; therefore, by means of the simple and efficient high-compression technology provided by the present invention, common consumers or persons in various specialized fields can easily store and carry a larger volume of gas, which is filled into a high pressure gas tank after being highly compressed, for various applications.

### DISCLOSURE OF THE INVENTION

An object of the present invention is to provide a filling machine for highly compressed gas which is a gas compressing machine using a high pressure while not using lubricant, whose function is to fill various highly compressed clean dry gas, such as oxygen, medical oxygen, nitrogen, argon, air, carbon dioxide, into an extra high pressure gas tank; the technical advantage of the present invention also lies in that it allows achievement of a filling pressure which is much higher than that generally provided in the current market, and therefore, the present invention can match and satisfy the need of an extra high pressure gas tank made of composite material available in the current market, which has a large capacity, and at the same time highly increases the speed for filling gas into a high pressure gas tank so that it substantially reduces the time for filling gas into a high pressure gas tank; therefore, by means of the simple and efficient high-compression technology provided by the present invention, common consumers or persons in various specialized fields can easily store and carry a larger volume of gas, which is stored into a high pressure gas tank after being highly compressed, for various applications.

A filling machine for highly compressed gas provided by the present invention mainly comprises: at least two oscillating type compression gas cylinders which are connected in series by a plurality of one-way valves and hoses so as to constitute a high-compression mechanism; a driving shaft; a plurality of eccentric driving wheels which are fixedly mounted on the driving shaft in sequence spaced apart by a selected angle so as to constitute a eccentric driving mechanism; an electric driver; a mechanical reduction gearbox which is connected to the electric driver; a supporting shaft which is fixedly mounted in a solid upright framework, wherein the driving shaft extending from the reduction gearbox is supported by the two side walls of the framework; the heads of the at least two oscillating type compression gas cylinders is fitted over one supporting shaft; a piston, a piston rod and a slip ring are fixedly joined into an integral block, wherein the slip ring is fitted over the eccentric driving wheel and the eccentric driving wheel is rotatable with respect to the slip ring; when the electric driver is powered, the electric driver rotates and drives the reduction gearbox to reduce the rotation speed according to a reduction ratio and transfer the rotation movement to the driving shaft so that the driving shaft rotates at a low speed and a large torque; when the driving shaft rotates at a low speed, the center of the eccentric driving wheel rotates clockwise along a circular trace, and the movement trace of the center of the eccentric driving wheel is centered on the driving shaft; when the center of the eccentric driving wheel performs a circular movement, the eccentric driving wheel immediately drives the integral block of the slip ring, the piston rod and the piston to reciprocate linearly with respect to the gas cylinder barrel; the electric driver, the reduction gearbox, the eccentric driving wheel and the driving shaft jointly compose an eccentric driving mechanism which operates to drive at least two oscillating type compression gas cylinders to perform a gas compressing operation successively; the cylinder bores of the at least two compression gas cylinders decrease stage by stage in sequence, wherein the cylinder bore of the first stage compression gas cylinder is the largest, the cylinder bore of the second stage compression gas cylinder is relatively smaller and the cylinder bore of the third or higher stage compression gas cylinder is seven smaller in sequence, and the cylinder bore of the highest stage compression gas cylinder is the smallest.

The high-compression technology of the filling machine for highly compressed gas provided by the present invention has a process as follows:

The head of the first stage compression gas cylinder is fitted over the supporting shaft and the other end of the compression gas cylinder is connected to the piston and the piston rod, with the other end of the piston rod being fixedly joined to the slip ring so as to be fitted over the eccentric driving wheel together; when the electric driver is powered, the power drives the driving shaft via the reduction gearbox to rotate clockwise slowly, and subsequently drives the eccentric driving wheel secured on the driving shaft to rotate simultaneously, wherein the movement trace of the center of the eccentric driving wheel is centered on the driving shaft; when the center of the eccentric driving wheel performs a circular movement, the eccentric driving wheel immediately drives the integral block of the slip ring, the piston rod and the piston to reciprocate linearly with respect to the gas cylinder barrel, and simultaneously drives the gas cylinder barrel, the piston, the piston rod and the slip ring to oscillate back and forth in a left-and-right direction by a certain angle in a plane together, taking the supporting shaft as a center. A cylinder manifold mounted on the top of the upright frame is provided with an inlet for introducing low pressure gas and when the piston and the piston rod move away from the head of the gas cylinder barrel towards the other end, the low pressure gas is drawn into the chamber inside the first stage compression gas cylinder via the inlet through a hose and an one-way valve; in this manner, the piston and the piston rod move towards the head of the gas cylinder barrel, compresses the gas in the chamber, and the gas, after being compressed by the first stage compression gas cylinder, enters into the chamber of the second stage compression gas cylinder; then the second stage gas compressing stroke begins and the gas, after being compressed by the second stage compression gas cylinder, enters into the chamber of the third stage compression gas cylinder so as to undergo the third stage gas compressing stroke; after being compressed in two or more stages, the gas reaches a preset value of pressure so as to be output via a preset outlet, for being filled into an extra high pressure gas tank. The filling machine for highly compressed gas according to the present invention is provided with a cooling fan, and the outer circumferential portions of the plurality of oscillating type compression gas cylinders in the present invention are provided with bump-and-depression textures for heat elimination, wherein the cooling fan directly blows onto the at least two oscillating type compression gas cylinders arranged side by side so that the compression gas cylinders can be maintained at a suitably low temperature, and a water cooling type heat elimination means can also be used to maintain the compression gas cylinders at a suitably low temperature; the solid upright framework used in the present invention is provided with a rigid transparent cover which operates to avoid or mitigate any possible damage caused to the operating components inside the framework by external impacts, wherein the rigid transparent cover is made of an infrangible rigid transparent film which is made of polycarbonate, or made of a toughened infrangible glass; the operation of the gas compressing mechanism can be clearly seen from outside through the rigid transparent cover, and of course, it is also possible to select covers made of other materials; the cylinder manifold mounted on the top of the upright frame is provided with a pressure switch which operates to adjust and calibrate the pressure switch to a preset value of pressure, and when the pressure of the output highly-compressed gas exceeds the preset value of pressure, the pressure switch shuts off the input power so as to stops the gas compressing operation of the filling machine for highly compressed gas and sends a prompt signal; the cylinder manifold is also provided with a pressure gauge which shows the pressure of the output highly-compressed gas, and also provided with a safety valve which discharges the highly-compressed gas when the pressure of the output highly-compressed gas exceeds the preset value of pressure to ensure safety.

The present invention illustrates a filling machine for highly compressed gas in the best mode for carrying out the invention portion of its specification, which has three oscillating type compression gas cylinders arranged in series. However, the present invention is not limited to this and can use at least two oscillating type compression gas cylinders according to practical requirements.

### BRIEF DESCRIPTION OF THE DRAWINGS

FIG. 1 is a front view of a filling machine for highly compressed gas according to the present invention, shown in an operating state at a first stage of gas compressing, wherein its eccentric driving wheel is located at a 0° position.

FIG. 2 is an A-A sectional view of the filling machine for highly compressed gas according to an embodiment of the present invention in the operating state at the first stage of gas compressing as shown in FIG. 1, wherein its eccentric driving wheel is located at a 0° position, with the machine being viewed from one side.

FIG. 3 is a front view of the filling machine for highly compressed gas according to the present invention, shown in an operating state at a second stage of gas compressing, wherein its eccentric driving wheel is located at a 120° position.

FIG. 4 is a front view of the filling machine for highly compressed gas according to the present invention, shown in an operating state at a third stage of gas compressing state, wherein its eccentric driving wheel is located at a 240° position.

FIGS. 5 and 6 are perspective outside views of the filling machine for highly compressed gas according to the present invention.

### BEST MODE FOR CARRYING OUT THE INVENTION

The principle and structure of the present invention will now be explained in detail by means of embodiments with reference to figures; however, the embodiments are only provided for illustration, but not to limit the practical extent of the present invention and the protection scope of its claims.

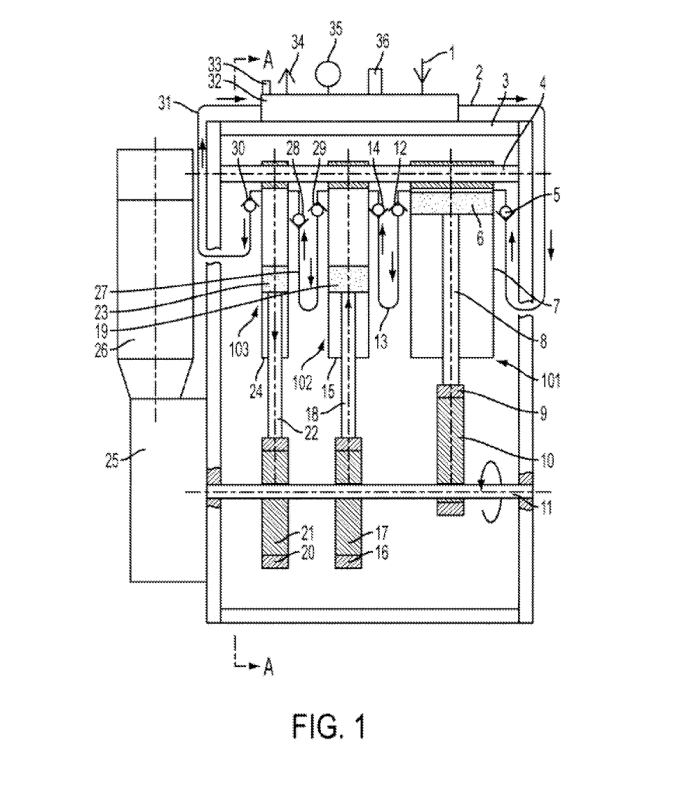

As shown in FIGS. 1-4, according to a filling machine for highly compressed gas 100 in a preferred embodiment of the present invention, the operation organization of the present invention mainly comprises an eccentric driving mechanism and a set of oscillating type driving mechanisms; the eccentric driving mechanism mainly consists of an electric driver 26, a reduction gearbox 25, a driving shaft 11 and three eccentric driving wheels 10, 17 and 21. According to the preferred embodiment of the present invention, the set of oscillating type driving mechanisms comprises three oscillating type compression gas cylinders 101, 102 and 103, each consisting of a plurality of one-way valves and hoses connected in series.

As shown in the front view of FIG. 1, an electric driver 26 is directly connected to a mechanical reduction gearbox 25 which is secured to a framework 3, and a driving shaft 11 extending from the reduction gearbox 25 is supported by the two side walls of the framework 3, three eccentric driving wheels 10, 17 and 21 being fixedly mounted on the driving shaft 11; when the electric driver 26 is powered, it begins to rotate, drives the reduction gearbox 25 which reduces the rotation speed at a reduction ratio and subsequently transfers the rotation movement to the driving shaft 11, and therefore, the driving shaft 11 rotates at a low rotation speed and a large torque.

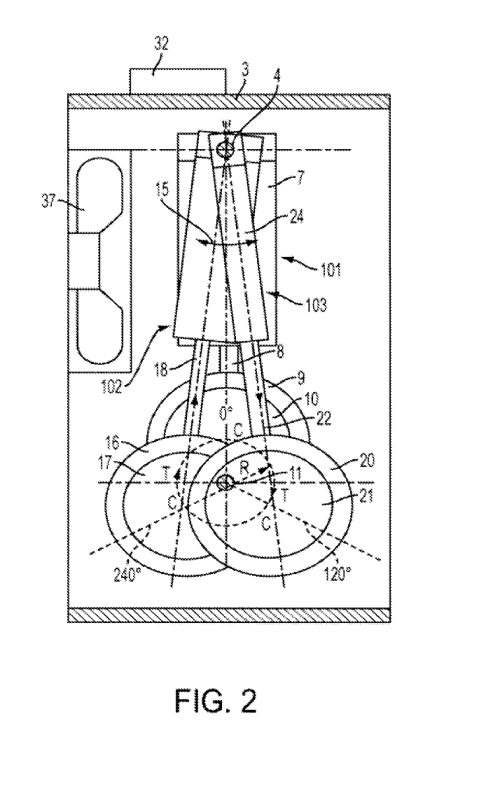

As shown in FIGS. 1 and 2, there are three eccentric driving wheels 10, 17 and 21 secured on the driving shaft 11; the three eccentric driving wheels 10, 17 and 21 are fixedly mounted on the driving shaft in sequence, spaced apart by an angle of 120°. Each of the three eccentric driving wheels 10, 17 and 21 has an eccentric distance “R” (with reference to FIG. 2), that is, a center of each of the three eccentric driving wheels 10, 17 and 21 is point “C”, and a center distance between each of the three eccentric driving wheels 10, 17 and 21 and the driving shaft 11 is also the distance “R”. When the driving shaft 11 rotates at a low speed, the points “C”, which are the centers of the three eccentric driving wheels 10, 17 and 21, rotate clockwise along a movement trace “T” (with reference to FIG. 2).

In this manner, as discussed above, an eccentric driving mechanism consisting of the electric driver 26, the reduction gearbox 25, the driving shaft 11 and the three eccentric driving wheels 10, 17 and 21 acts on the three oscillating type compression gas cylinders 101, 102 and 103, so as to perform a gas compressing operation. The eccentric driving mechanism according to the present invention is not limited to the above embodiment. As long as the driving shaft 11 is rotated by any prime power to drive the oscillating type compression gas cylinders fixedly mounted on the driving shaft 11, it falls into the technical field of the present invention and the protection scope of the its claims.

With reference to FIG. 1, a head of a cylinder barrel 7 of a first stage compression gas cylinder 101 is fitted over a supporting shaft 4. A piston 6, a piston rod 8 and a slip ring 9 are fixedly joined into an integral block. The slip ring 9 is fitted over the eccentric driving wheel 10 which is rotatable with respect to the slip ring 9.

With reference to FIG. 1, a head of a cylinder barrel 15 of a second stage compression gas cylinder 102 is fitted over the supporting shaft 4. A piston 19, a piston rod 18 and a slip ring 16 are fixedly joined into an integral block. The slip ring 16 is fitted over the eccentric driving wheel 17 which is rotatable with respect to the slip ring 16.

With reference to FIG. 1, a head of a cylinder barrel 24 of a third stage compression gas cylinder 103 is fitted over the supporting shaft 4. A piston 23, a piston rod 22 and a slip ring 20 are fixedly joined into an integral block. The slip ring 20 is fitted over an eccentric driving wheel 21 which is rotatable with respect to the slip ring 20.

The cylinder bores of the three gas cylinders 101, 102 and 103 of different stages decrease stage by stage; the cylinder bore of the first stage compression gas cylinder 101 is the largest, the cylinder bore of the second stage compression gas cylinder 102 is the middle, and the cylinder bore of the third stage compression gas cylinder 103 is the smallest.

The dynamic process of the compressing gas operation of each compression gas cylinders is now discussed respectively (as follow):

Gas compression at the first stage (with reference to FIGS. 1 and 2):

The head of the first stage compression gas cylinder 101 is fitted over the supporting shaft 4 and the other end of the compression gas cylinder 101 is connected to one end of the piston rod 8, with the other end of the piston rod 8 being fixedly joined to the slip ring 9 so as to be fitted over one eccentric driving wheel 10 together (with reference to FIG. 1).

When the electric driver 26 is powered, the power drives the driving shaft 11 via the reduction gearbox 25 to rotate clockwise slowly (with reference to FIG. 2), and subsequently drives the eccentric driving wheel 10 secured on the driving shaft 11 to rotate simultaneously, wherein the movement trace of the center “C” of the eccentric driving wheel 10 is a circle “T” centered on the driving shaft 11 and having a radius “R” (with reference to FIG. 2).

When the center of the eccentric driving wheel 10 performs a circular movement along the movement trace “T”, the eccentric driving wheel 10 drives the integral block of slip ring 9, the piston rod 8 and the piston 6 to reciprocate linearly with respect to the gas cylinder barrel 7 of the compression gas cylinder 101, and simultaneously drives the gas cylinder barrel 7, the piston 6, the piston rod 8 and the slip ring 9 to oscillate back and forth in a left-and-right direction by a certain angle in a plane together, taking the supporting shaft 4 as a center (with reference to FIG. 2).

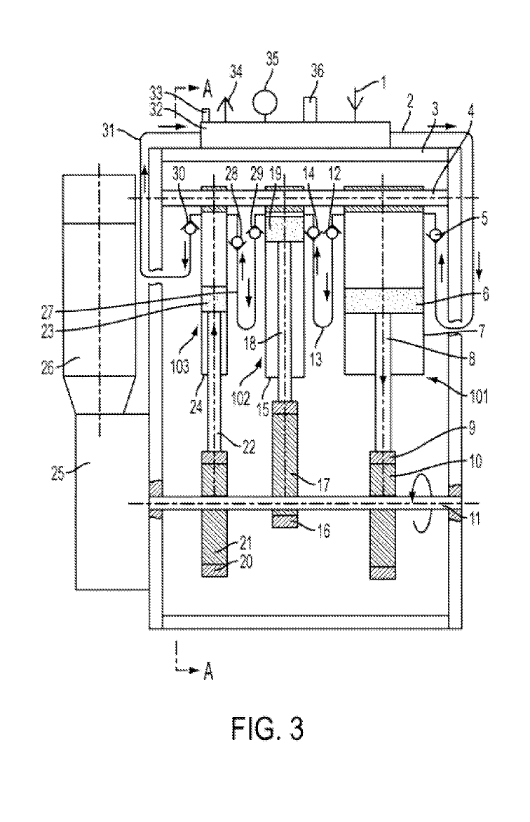

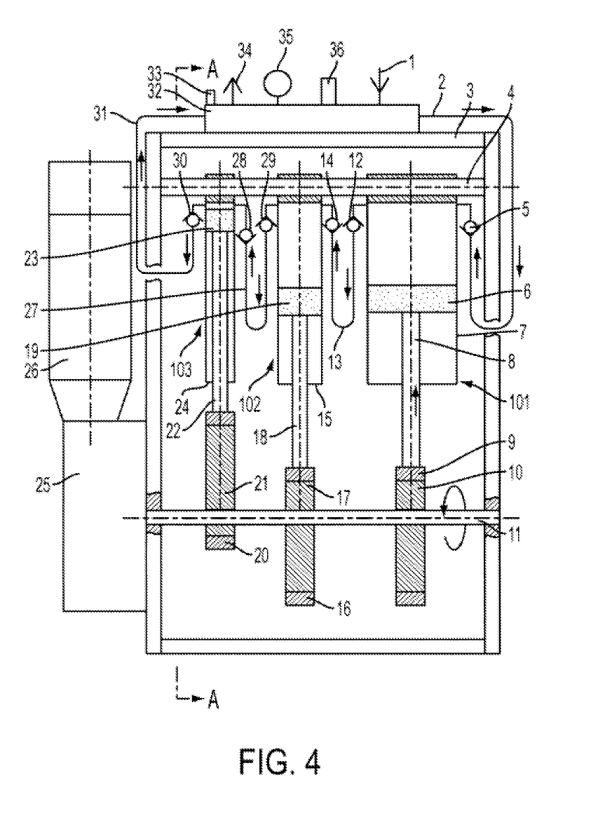

With reference to FIG. 3, a cylinder manifold 32 is provided with an inlet 1 for introducing low pressure gas. When the piston 6 and the piston rod 8 moves downwardly away from the head of the gas cylinder barrel 7, the low pressure gas is drawn into the chamber 201 inside the first stage compression gas cylinder 101 via the inlet 1 through a hose 2 and an one-way valve 5; this is a gas aspirating stroke of the first stage compression gas cylinder 101. With reference to FIG. 4, when the piston 6 and the piston rod 8 moves upwardly towards the head of the gas cylinder barrel 7, the gas in the chamber 201 is compressed by the piston 6 and then enters into the chamber 202 inside the second stage compression gas cylinder 102 via the inlet 1, a hose 2 and an one-way valve 5; this is a gas compressing stroke of the first stage compression gas cylinder 101. With reference to FIGS. 1 and 2, when the piston 6 of the first stage compression gas cylinder 101 reaches the top dead point, the gas compressing stroke ends and the next gas compressing cycle begins.

Gas compression at the second stage (with reference to FIGS. 1 and 2):

The head of the second stage compression gas cylinder 102 is fitted over the supporting shaft 4 and the other end of the compression gas cylinder 102 is connected to one end of the piston rod 18, with the other end of the piston rod 18 fixedly joined to the slip ring 16 so as to be fitted over one eccentric driving wheel 17 together (with reference to FIGS. 1 and 2).

When the eccentric driving wheel 17 rotates, the eccentric driving wheel 17 drives the integral block of slip ring 16, the piston rod 18 and the piston 19 to reciprocate linearly with respect to the gas cylinder barrel 15 of the compression gas cylinder 102 and simultaneously drives the gas cylinder barrel 15, the piston 19, the piston rod 18 and the slip ring 16 to oscillate back and forth in a left-and-right direction by a certain angle in a plane together, taking the supporting shaft 4 as a center (with reference to FIG. 2).

With reference to FIG. 4, when the piston 19 and the piston rod 18 moves downwardly away from the head of the gas cylinder barrel 15, the compressed gas from the first stage compression gas cylinder 101 is drawn into the chamber 202 of the second stage compression gas cylinder 102; this is a gas aspirating stroke of the second stage compression gas cylinder 102.

With reference to FIG. 4, when the piston 19 and the piston rod 18 moves upwardly towards the head of the gas cylinder barrel 15, the gas in the chamber 202 is compressed by the piston 19 and then enters into the chamber 203 inside the third stage compression gas cylinder 103 via an one-way valve 29, a hose 27 and an one-way valve 28; this is a gas compressing stroke of the second stage compression gas cylinder 102. With reference to FIG. 3, when the piston 19 of the second stage compression gas cylinder 102 reaches the top dead point, the gas compressing stroke ends and the next gas compressing cycle begins.

Gas compression at the third stage (with reference to FIGS. 1 and 2):

The head of the third stage compression gas cylinder 103 is fitted over the supporting shaft 4 and the other end of the compression gas cylinder 103 is connected to one end of the piston rod 22, with the other end of the piston rod 22 fixedly joined to the slip ring 20 so as to be fitted over one eccentric driving wheel 21 together (with reference to FIGS. 1 and 2).

When the eccentric driving wheel 21 rotates, the eccentric driving wheel 21 drives the integral block of slip ring 20, the piston rod 22 and the piston 23 to reciprocate linearly with respect to the gas cylinder barrel 24 of the compression gas cylinder 103 and simultaneously drives the gas cylinder barrel 24, the piston 23, the piston rod 22 and the slip ring 20 to oscillate back and forth in a left-and-right direction by a certain angle in a plane together, taking the supporting shaft 4 as a center (with reference to FIG. 2).

With reference to FIG. 1, when the piston 23 and the piston rod 22 moves downwardly away from the head of the gas cylinder barrel 24, the compressed gas from the second stage compression gas cylinder 102 is drawn into the chamber 203 inside the third stage compression gas cylinder 103; this is a gas aspirating stroke of the third stage compression gas cylinder 103.

With reference to FIG. 3, when the piston 23 and the piston rod 22 moves upwardly towards the head of the gas cylinder barrel 24, the gas in the chamber 203 is compressed by the piston 23, completing a gas compressing stroke of the third stage compression gas cylinder 103, and then enters into the cylinder manifold 32 via an one-way valve 30 and a hose 31; this is a gas compressing stroke of the third stage compression gas cylinder 103. With reference to FIG. 4, when the piston 23 of the third stage compression gas cylinder 103 reaches the top dead point, the gas compressing stroke ends.

With reference to FIGS. 1, 3, 4 and 5, the cylinder manifold 32 is provided with an outlet 34, through which the high pressure gas which has been compressed is output, to be filled into a high pressure gas tank; the cylinder manifold 32 is provided with a pressure switch 26 which can adjust the pressure to a preset value of pressure; when the pressure of the highly-compressed gas output from the third stage compression gas cylinder 103 reaches the preset value of pressure, the pressure switch 26 shuts off the power to the electric driver 26, immediately stops the operation of the filling machine for highly compressed gas 100 and sends a signal; the cylinder manifold 32 is also provided with a pressure gauge 35 which can show the pressure of the output highly-compressed gas; the cylinder manifold 32 is further provided with a safety valve 33 which will immediately discharge the highly compressed gas if the pressure of the output highly-compressed gas exceeds the preset value of pressure.

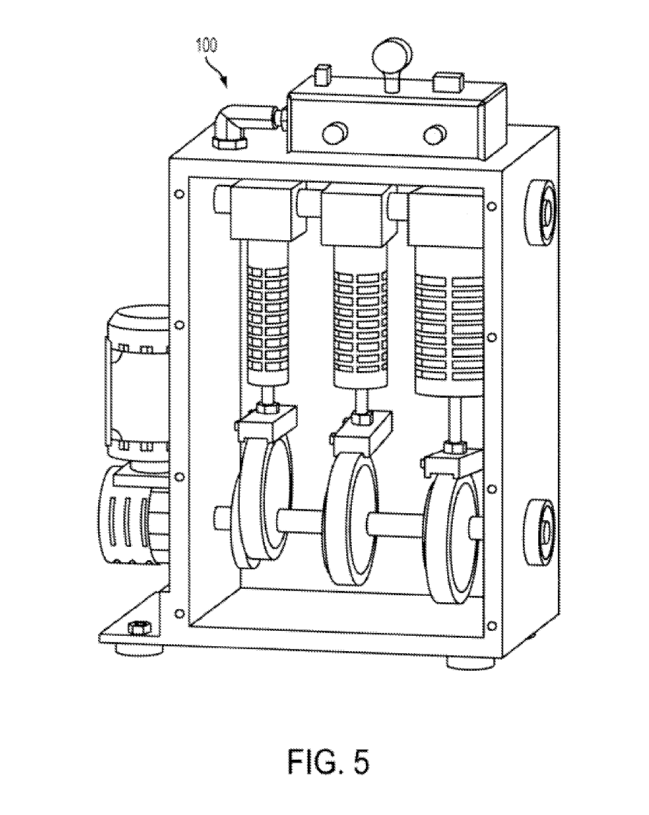

With reference to FIGS. 2 and 5, the highly-compressed gas filling machine 100 according to the present invention is provided with a cooling fan 37, and the outer circumferential portions of the three oscillating type compression gas cylinders 101, 102 and 103 as shown in the preferred embodiment of the present invention are provided with bump-and-depression textures 38 for heat elimination. A cooling fan 37 mounted in the framework directly blows onto the three oscillating type compression gas cylinders 101, 102 and 103 disposed side by side so that the compression gas cylinders 101, 102 and 103 can be maintained at a suitably low temperature.

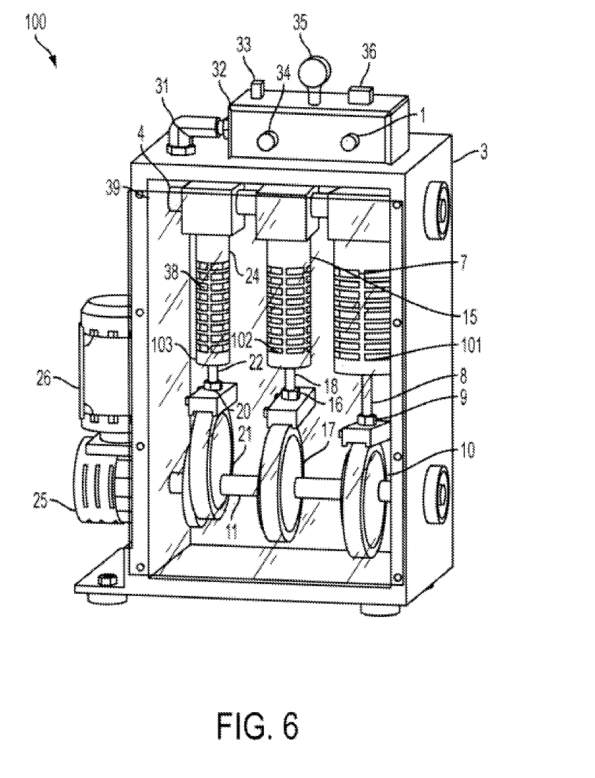

With reference to FIG. 6, the filling machine for highly compressed gas 100 according to the present invention is provided with a rigid transparent cover 39, so as to avoid or mitigate any possible damage caused to the operating components inside the framework by external impacts. The transparent cover 39 is made of an infrangible rigid transparent film which is made of polycarbonate. The operation of the filling machine for highly compressed gas can be clearly seen from outside through the transparent cover 39.

In the above embodiment, the filling machine for highly compressed gas 100 according to the present invention uses three oscillating type compression gas cylinders 101, 102 and 103 arranged in series; however, the present invention is not limited to this, it can use any number of, but at least two, oscillating type compression gas cylinders according to practical requirements.

1. A filling machine for highly compressed gas, wherein it comprises an electric driver, a reduction gearbox, a driving shaft, a set of eccentric driving mechanisms, a set of high-compression mechanisms, a cylinder manifold and a framework;
the electric driver is connected to the reduction gearbox;
the driving shaft extends from the reduction gearbox; when the electric driver is powered, the power drives the driving shaft via the reduction gearbox to rotate clockwise slowly;
the driving shaft drives the set of eccentric driving mechanisms; when the electric driver is powered, the power drives the driving shaft via the reduction gearbox to rotate clockwise slowly and subsequently drives the eccentric driving mechanism fixedly mounted on the driving shaft to rotate simultaneously;
the set of eccentric driving mechanisms comprises at least two eccentric driving wheels which are fixedly mounted on the driving shaft in sequence, spaced apart by a selected angle; when the electric driver is powered, the power drives the driving shaft via the reduction gearbox to rotate clockwise slowly so that it drives the at least two eccentric driving wheels mounted on the driving shaft to rotate simultaneously and subsequently drives an integral block of a slip ring, a piston rod and a piston to reciprocate linearly with respect to a gas cylinder barrel so that each associated oscillating type compression gas cylinder performs a gas compressing operation;
the set of high-compression mechanisms comprises at least two oscillating type compression gas cylinders of different sizes, and a plurality of one-way valves and hoses, so that the plurality of oscillating type compression gas cylinders are connected in series into the set of high-compression mechanisms, with the cylinder bore of each oscillating type compression gas cylinder decreasing stage by stage from the first stage compression gas cylinder in sequence, the outer circumferential portion of each oscillating type compression gas cylinder being provided with bump-and-depression textures for heat elimination; each oscillating type compression gas cylinder is provides with a chamber inside it and an integral block comprised of a piston, a piston rod and a slip ring fixedly joined together, the slip ring being fitted over an eccentric driving wheel and the head of each oscillating type compression gas cylinder being fitted over a same supporting shaft mounted in the framework; when each eccentric driving wheel rotates, it immediately drives the associated integral block of the slip ring, the piston rod and the piston, together with the associated gas cylinder barrel, to oscillate back and forth in a left-and-right direction by a certain angle in a plane, taking a supporting shaft as a center; thus, each associated oscillating type compression gas cylinder performs a gas compressing operation successively by size;
the cylinder manifold comprises an inlet, a pressure switch, a pressure gauge, a safety valve and a outlet; the cylinder manifold is mounted on the top of a framework;
the inlet provided on the cylinder manifold operates to introduce low pressure gas so that the gas undergo a compressing stroke;
the pressure switch provided on the cylinder manifold operates to adjust and calibrate the pressure switch to a desired preset value of pressure;
the pressure gauge provided on the cylinder manifold operates to show the pressure of the output highly-compressed gas;
the safety valve provided on the cylinder manifold discharges the highly-compressed gas when the pressure of the output highly-compressed gas exceeds the preset value of pressure to ensure safety;
the outlet provided on the cylinder manifold outputs the compressed gas when the gas completes its preset high-compression operation of two or more stages, for being filled into a high pressure gas tank;
the framework comprises a supporting shaft, a cooling fan and a transparent cover; the framework is a solid upright framework;
the supporting shaft provided in the framework supports each oscillating type compression gas cylinder, the head of which is fitted over the same supporting shaft;
the cooling fan provided in the framework directly blows onto the at least two oscillating type compression gas cylinders arranged side by side so that the compression gas cylinders can be maintained at a suitably low temperature;
the transparent cover provided in the framework is mounted on the front of the framework and is made of a rigid transparent film so that the transparent cover operates to avoid or mitigate any possible damage caused to the operating components inside the framework by external impacts.

2. The filling machine for highly compressed gas according to claim 1, wherein the reduction gearbox is provided a driving shaft extending therefrom; when the power drives the driving shaft via the reduction gearbox to rotate clockwise slowly, it immediately drives the at least two eccentric driving wheels mounted on the driving shaft to rotate simultaneously, wherein the movement trace of the center of each eccentric driving wheel is a circle centered on the driving shaft.

3. The filling machine for highly compressed gas according to claim 1, wherein the set of eccentric driving mechanisms is provided with at least two eccentric driving wheels fixedly mounted on the driving shaft in sequence, spaced apart by an angle of 120°, wherein the first eccentric driving wheel is mounted on the driving shaft with an angle of 0°, while the third eccentric driving wheel is mounted on the driving shaft with an angle of 240°; the at least two eccentric driving wheels drive the set of at least two oscillating type compression gas cylinders so as to perform a gas compressing operation of two or more stages;
the center of each eccentric driving wheel is a center “C”, the eccentric distance of each eccentric driving wheel is a distance “R” and the center distance between each eccentric driving wheel and the driving shaft is also the distance “R”; when the driving shaft rotates at a low speed, the center “C”, which is the center of each eccentric driving wheel, rotates clockwise along a movement trace “T”, wherein the movement trace of the center of each eccentric driving wheel is centered on the driving shaft; when the electric driver is powered, the power drives the driving shaft via the reduction gearbox to rotate clockwise slowly, and subsequently drives the at least two eccentric driving wheels mounted on the driving shaft to rotate simultaneously, wherein the center of each eccentric driving wheel rotates clockwise along a circular movement trace, and it immediately drives the associated integral block of the slip ring, the piston rod and the piston to reciprocate linearly with respect to the gas cylinder barrel so that each associated oscillating type compression gas cylinder performs the gas compressing operation.

4. The filling machine for highly compressed gas according to claim 1, wherein the filling machine for highly compressed gas uses three eccentric driving wheels mounted on the same driving shaft so as to constitute an eccentric driving mechanism.

5. The filling machine for highly compressed gas according to claim 1, wherein the set of high-compression mechanisms comprises at least two oscillating type compression gas cylinders of different sizes, wherein the cylinder bore of each oscillating type compression gas cylinder decreases stage by stage from the first stage compression gas cylinder in sequence;
the set of high-compression mechanisms further comprises a plurality of one-way valves and hoses so that the plurality of oscillating type compression gas cylinders are connected in series into the set of high-compression mechanisms, wherein the head of each gas cylinder barrel is fitted over the same supporting shaft;
the set of high-compression mechanisms further comprises: each oscillating type compression gas cylinder comprises the associated integral block of the piston, the piston rod and the slip ring, wherein the slip ring is fitted over an eccentric driving wheel;
when each eccentric driving wheel rotates, it drives the integral block of the slip ring, the piston rod and the piston fitted thereover to reciprocate linearly with respect to the associated gas cylinder barrel so that the set of high-compression mechanisms performs the preset gas compressing operation; the at least two oscillating type compression gas cylinders are driven by the corresponding at least two eccentric driving wheels, so as to perform the gas compressing operation of two or more stages; the pressures reached in the compression gas cylinders increase stage by stage from the first stage, and after compressed by the third stage compression gas cylinder, the pressure of the output gas is up to 3000 psi, for being filled into an extra high pressure gas tank.

6. The filling machine for highly compressed gas according to claim 1, wherein the filling machine for highly compressed gas uses three oscillating type compression gas cylinders arranged in series.

7. The filling machine for highly compressed gas according to claim 1, wherein the hose connected to each oscillating type compression gas cylinder is provided with an one-way valve so that the compressed gas passing through each stage cannot flow backwards.

8. The filling machine for highly compressed gas according to claim 1, wherein each oscillating type compression gas cylinder is connected to the piston and the piston rod in a precise sealing design so as to ensure that the gas compressing operation can achieve a high pressure standard.

9. The filling machine for highly compressed gas according to claim 1, wherein each oscillating type compression gas cylinder comprises a chamber inside it to provide a sealed space for gas compressing; the cylinder bore of each oscillating type compression gas cylinder decreases stage by stage from the first stage compression gas cylinder in sequence; the outer circumferential portion of each oscillating type compression gas cylinder is provided with bump-and-depression textures for heat elimination.

10. The filling machine for highly compressed gas according to claim 1, wherein the inlet operates to introduce low pressure gas to receive a compressing stroke; the pressure switch operates to adjust and calibrate the pressure switch to a desired preset value of pressure; the pressure gauge shows the pressure of the output highly-compressed gas; the safety valve discharges the highly-compressed gas when the pressure of the output highly-compressed gas exceeds the preset value of pressure to ensure safety; the outlet outputs the compressed gas when the gas completes its preset high-compression operation of two or more stages, for being filled into a high pressure gas tank.

11. The filling machine for highly compressed gas according to claim 1, wherein the pressure switch operates to adjust and calibrate the pressure switch to a desired preset value of pressure; when the pressure of the output highly-compressed gas exceeds a certain preset value of pressure, the pressure switch shuts off the input power, immediately stops the ongoing gas compressing operation and sends a prompt signal.

12. The filling machine for highly compressed gas according to claim 1, wherein the pressure gauge shows the pressure of the output highly-compressed gas.

13. The filling machine for highly compressed gas according to claim 1, wherein the safety valve discharges the highly-compressed gas when the pressure of the output highly-compressed gas exceeds the preset value of pressure to ensure safety.

14. The filling machine for highly compressed gas according to claim 1, wherein the outlet outputs the compressed gas when the gas completes its preset high-compression operation of two or more stages for being filled into a high pressure gas tank.

15. The filling machine for highly compressed gas according to claim 1, wherein the framework is a solid upright framework and the framework further comprises a supporting shaft, a cooling fan and a transparent cover; the supporting shaft operates to support each oscillating type compression gas cylinder, the head of the gas cylinder barrel of which is fitted over the same supporting shaft.

16. The filling machine for highly compressed gas according to claim 1, wherein the supporting shaft is mounted in an upright framework and the supporting shaft supports each oscillating type compression gas cylinder, the head of the gas cylinder barrel of which is fitted over the same supporting shaft.

17. The filling machine for highly compressed gas according to claim 1, wherein the cooling fan is mounted in an upright framework, which operates to directly blow onto the at least two oscillating type compression gas cylinders arranged side by side so that the compression gas cylinders can be maintained at a suitably low temperature.

18. The filling machine for highly compressed gas according to claim 1, wherein the transparent cover is mounted on the front of an upright framework and is made of a rigid transparent film so that the transparent cover operates to avoid or mitigate any possible damage caused to the operating components inside the framework by external impacts; the operation of the gas compressing mechanism in the framework can be clearly seen through the transparent cover; the transparent cover is made of an infrangible rigid transparent film which is made of polycarbonate, or the transparent cover can be made of other rigid materials.
